(19) United States
(12) Patent Application Publication
(10) Pub. No.: US 2012/0079052 A1
(43) Pub. Date: Mar. 29, 2012

(54) CONTROL UNIT IN A NETWORK, NETWORK, AND ROUTING METHOD FOR MESSAGES IN A NETWORK

(76) Inventors: Bernd Lutz, Horb (DE); Stoyan Todorov, Mannheim (DE)

(21) Appl. No.: 13/138,624

(22) PCT Filed: Feb. 19, 2010
(86) PCT No.: PCT/EP2010/052146

§ 371 Date: Dec. 5, 2011

(30) Foreign Application Priority Data
Mar. 31, 2009 (DE) 10 2009 002 007.1

(51) Int. Cl. G06F 15/16

(52) U.S. Cl. 709/207

(57) ABSTRACT

In a routing method for messages in a network, at least two adjacent network controllers exchange priority information of stored messages and compare this priority information. Furthermore, in the event that the message memory of one of the two network controllers is full, a lower-priority message in the full memory is replaced with a higher-priority message from the adjacent network controller as a function of the comparison of the priority information. The replacing message is provided for transmission on and/or via the full network controller.

### BACKGROUND OF THE INVENTION

1. Field Of The Invention

The present invention relates to a control unit in a network, a network, and a routing method for messages in a network.

2. Description Of Related Art

Networks are currently used in many fields; i.e., components exchange data packets via network structures such as network controllers. Depending on the design of a network, however, congestion may occur in the forwarding from one network controller to another; i.e., packets cannot be forwarded because the buffers of the subsequent controllers are not able to receive additional packets. This effect is observed in practically all network designs, and in the best case the probability of occurrence may be minimized.

In the research field, the congestion problem is usually solved using adaptive routing algorithms which recognize congestion and correspondingly use alternative routes for data packets. However, these methods depend on a large number of possible routes, and likewise may not be able to completely solve the congestion problem. Published European patent document EP 1895720 A1 provides an example of one approach to the problem using adaptive routing methods in an on-chip network.

For certain applications of networks, for example on-chip networks in motor vehicle control units, congestion as well as adaptive routing algorithms result in nondeterministic packet propagation times, and thus, unpredictable overall timing response in the control unit. Furthermore, adaptive routing methods require additional outlays, such as extra space due to additional logic systems on the controllers, in order to be able to optimally determine a route.

### BRIEF SUMMARY OF THE INVENTION

The present invention provides a network controller in a network, a network, and a routing method for messages in a network, which network controllers in the network exchange priority information concerning the messages stored in their message memories. In the event of message congestion, i.e., congestion of a full message memory of a first of the network controllers, by comparing the priority information a process may be initiated in which a first lower-priority message in the full message memory is exchanged, i.e., replaced, with a second higher-priority message from a message memory of a second, adjacent network controller, the second message being provided for transmission into the full message memory of the first network controller. Thus, the present invention describes an advantageous routing method for reducing negative effects of message congestion or for reducing message congestion with comparatively low computing effort; this method is able in particular to reduce the propagation times of messages of high/highest priority in the event of message congestion. One particular advantage is that the routing functions without complicated computer equipment for adaptive/dynamic route planning, and in addition, information storage such as propagation time tables and the like is not required; instead, the congestion problem is addressed by easily implemented communication of two adjacent network controllers of a network. Technical complexity and therefore costs are thus spared. The routing according to the present invention is thus particularly advantageous for on-chip networks or networks on a printed circuit board, for example, in which space and cost savings are particularly important.

In one advantageous embodiment, a network controller initiates a message exchange when its message memory is full, and by comparing the priority information of its own messages to the received priority information of the messages of an adjacent controller determines that in the adjacent controller a message of higher priority than the priority of a message stored in its own, full message memory is provided for the transmission into the full message memory. This embodiment achieves the described advantages of the routing method for the case that the message memory of a network controller according to the present invention is full. It is advantageous that only the initiating network controller needs to be designed for comparing the priority information and for initiating a message exchange; for example, such a network controller may be used on a network node which is particularly susceptible to having a full message memory.

Another advantageous embodiment is directed to a network controller which initiates a message exchange when the message memory of its adjacent controller is full, and by comparing the priority information of its own messages to the received priority information of the messages of an adjacent controller determines that a message is stored in the adjacent controller which has a lower priority than a message that is stored in its own message memory of the network controller, and is provided for a transmission into the message memory of the adjacent controller. This embodiment achieves the described advantages of the routing method for the case that the message memory of an adjacent controller of a network controller according to the present invention is full. It is advantageous that only the initiating network controller needs to be designed for comparing the priority information and for initiating a message exchange; for example, such a network controller may be used adjacently to a network node which is particularly susceptible to having a full message memory.

In another advantageous embodiment, lower-priority messages may be elevated in priority by the network controllers as a function, for example, of the number of replacement operations and/or the number of network controllers visited. The situation may thus be avoided that lower-priority messages have very long propagation times, or in the extreme case never even reach the destination, due to message congestion and in particular also due to the exchange with higher-priority messages.

The network controller according to the present invention may advantageously have a reserved memory location for buffering a message when messages of different priority are exchanged. In one particular embodiment, this memory location is implemented as a separate buffer of the network controller. As the result of a reserved memory location, in the event of message congestion messages of different priority may be exchanged even when the data transmission paths, the involved network controllers, or the messages to be exchanged are not suitable for simultaneous transmission or for simultaneous message exchange.

In one advantageous exemplary embodiment, the priority information between the two adjacent network controllers is transmitted via different data channels than the messages. Burdening the message transmission rate with further transmissions on the same data channels is thus avoided. In an alternative advantageous embodiment, the priority information is transmitted via the same data channels as the messages. The complexity of further connections may advantageously be avoided in this way.

It may be advantageous to provide the priority information of the messages in the data packet formats of the messages in order to avoid the complexity or the data load of additional transmission of priority information. Optionally, it may also be advantageous to transmit the priority information separately from, i.e., in addition to, the messages, for example for the case that a specified data packet format does not provide or allow storage of such information.

### BRIEF DESCRIPTION OF THE DRAWINGS

FIG. 1 shows a network.

FIG. 2 shows one example of an exchange according to the present invention of messages of different priority between two adjacent network controllers of a network.

### DETAILED DESCRIPTION OF THE INVENTION

The routing according to the present invention, i.e., the network controller according to the present invention and the network according to the present invention, is/are explained below using the particularly advantageous example of an on-chip network, without thereby limiting the present invention to this type of network. Rather, the present invention may also be used without limitation for other networks.

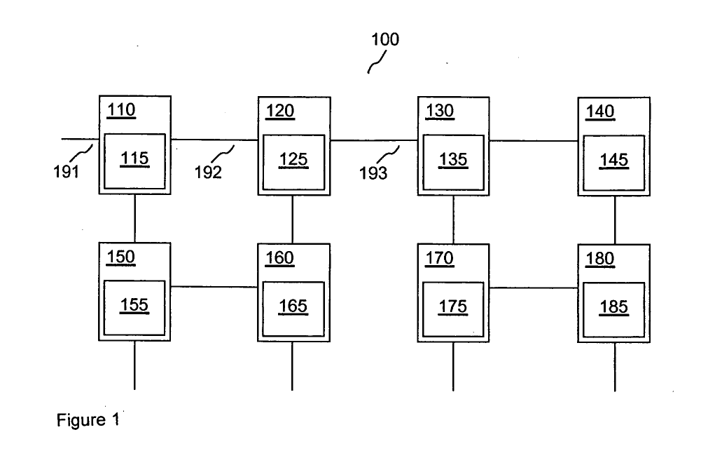

A typical on-chip network connects the components of a chip via a number of network controllers. These controllers by default usually have at least one internal buffer in which the controllers are able to buffer data packets prior to forwarding. FIG. 1 shows an on-chip network, for which an example of message congestion is to be explained. On-chip network 100 has network controllers 110, 120, 130, 140, 150, 160, 170, and 180, each having an internal memory system 115, 125, 135, 145, 155, 165, 175, and 185, respectively. In addition, network controller 110 is connected to communication connections 191 and 192, network controller 120 is likewise connected to communication connection 192 and also to communication connection 193, and network controller 130 is likewise connected to communication connection 193. The following are connected to one another via further communication connections: network controllers 110 and 150, 150 and 160, 160 and 120, 130 and 170, 130 and 140, 140 and 180, and 170 and 180. Network controllers 110, 150, 160, 170, and 180 each have a further communication connection to an adjacent network controller, not shown in FIG. 1.

Messages according to the related art are then conducted in this on-chip network 100 via routes which are fixed or also, for example, dynamically determined by the network. If the buffer/message memory of one network controller is full, in a standard design this network controller blocks the receipt of further packets. In a system design according to the present invention, an adjacent network controller which intends to send data to the blocking network controller is able to exchange priority information with the blocking network controller and forward high-priority messages to same. This results in a targeted exchange of messages of different priority between two network controllers in the event of congestion. On its route, the high-priority blocked message takes the place of a low-priority blocking message. The displaced message is assigned the place of the released high-priority message. Under certain circumstances, a definitely determinable maximum propagation time may thus be associated with a highest-priority message. For this purpose, the message priority is incorporated into the format of the data packet, for example, or is transmitted separately.

For example, message congestion results in on-chip network 100 in FIG. 1 between network controllers 110 and 120 when message memory 125 of network controller 120 is full, or is full for messages from network controller 110. The reason for such message congestion may, for example, be that in a given time period more messages, intended for retransmission via communication connection 193, arrive at network controller 120 via communication connection 192 than the network controller is able to forward via communication connection 193 in this time period. Another example of message congestion which may be resolved particularly well using the procedure according to the present invention is the case that communication connection 193 is blocked for low-priority messages from network controller 120, and network controller 120 has a full memory system 125 containing exclusively lower-priority messages.

Such message congestion is particularly critical for high-priority messages which are stored in message memory 115 of network controller 110 and which are intended for transmission via communication connection 192 to network controller 120, or via network controller 120 and forward via communication connection 193, for example.

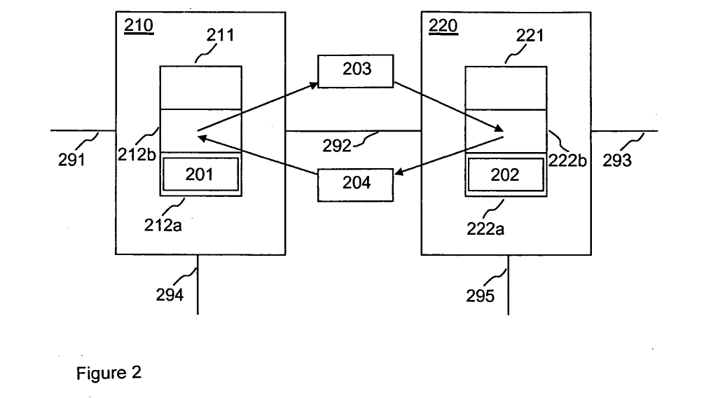

The routing according to the present invention is explained, with reference to FIG. 2, for various congestion problems, for example, also the message congestion described with reference to FIG. 1. FIG. 2 shows network controllers 210 and 220 which, similarly as for network controllers 110 and 120 from FIG. 1, are incorporated into an on-chip network. Network controller 210 has an internal memory system 211, 212a, 212b, and internal memory system 211, 212a, 212b has a buffer 211 and message memory segments 212a and 212b. In addition, network controller 210 is connected to communication connections 291, 292, and 294. Network controller 220 has an internal memory system 221, 222a, 222b, and internal memory system 221, 222a, 222b has a buffer 221 and message memory segments 222a and 222b. In addition, network controller 220 is connected to communication connections 292, 293, and 295. In the case shown in FIG. 2, a message 201 is stored in message memory segment 212a of network controller 210, and a message 202 is stored in message memory segment 222a of network controller 220. At the start of the routing described with reference to FIG. 2, it is assumed that message 203 is stored in message memory segment 212b of network controller 210, and that message 204 is stored in message memory segment 222b of network controller 220. Similarly to the case of message congestion described for FIG. 1, message memory 222a, 222b of network controller 220 is full with messages 202 and 204, respectively. In the example shown here, in addition message memory 212a, 212b of network controller 210 is full with messages 201 and 203, respectively.

According to the present invention, to solve the message congestion problem, at least for higher-priority messages, network controllers 210 and 220 exchange priority information concerning messages 201, 203 and 202, 204, respectively, stored in their message memories 212a, 212b and 222a, 222b, respectively. For example, by comparing the exchanged priority information it is determined that message 203 stored in network controller 210 is intended for transmission via communication connection 292 to network controller 220, or via network controller 220 forward to communication connections 293 or 295, and also that this message 203 has a higher priority than message 204 stored in network controller 220. Based on this determination and the message congestion identified as a result of full message memory 222a, 222b, messages 203 and 204 are then exchanged according to the present invention between network controllers 210 and 220; i.e., message 203 is transmitted from network controller 210 to network controller 220 and is deleted from message memory segment 212b of network controller 210; similarly, message 204 is transmitted from network controller 220 to network controller 210 and is deleted from message memory segment 222b of network controller 220.

This message exchange according to the present invention may, for example, occur simultaneously if communication connection 292 and network controllers 210 and 220 are designed accordingly.

Alternatively, as shown in FIG. 2, network controllers 210 and 220 may have buffers 211 and 221, respectively, in which messages 203 and 204 may be buffered during the message exchange.

The exchange protocol between network controller 210 and its adjacent controller 220 is described in greater detail below, with reference to FIG. 2 and two alternative examples.

In the first example, it is assumed that message memory 212a, 212b of network controller 210 is full, and that adjacent controller 220 has at least one message 204 stored in its message memory 222a, 222b which is provided for transmission via communication line 292 to network controller 210, or for transmission via communication line 292 and via network controller 210 forward via communication lines 291 or 294. Thus, message congestion exists between network controller 210 and adjacent controller 220. In the present example, adjacent controller. 220 now transmits the priority information of the highest-priority message which is provided for transmission on or via network controller 210, for example, transmission of message 204 to network controller 210. Alternatively, it may be provided that adjacent controller 220 transmits the priority information of all messages 202 and 204 stored in its message memory 222a, 222b, respectively, or at least of all messages 204 which are provided for transmission to network controller 210, to this network controller 210. Network controller 210 now compares the priority information received from adjacent controller 220 to the priority information of messages 201 and 203 stored in its message memory 212a, 212b, respectively. In the event that the priority of message 204 is higher than the priority of one of messages 201 and 203, network controller 210 initiates the exchange of messages with adjacent controller 220 via a signal. Similarly as in FIG. 1, for example the priority of message 203 is lower than the priority of message 204. Network controller 210 sends a notification of the planned exchange of messages 203 and 204 to adjacent controller 220, and this adjacent controller 220 optionally acknowledges with an acknowledgment signal to network controller 210. Message 204 is then transmitted from message memory segment 222b of adjacent controller 220 into message memory segment 212b of network controller 210, and thus overwrites message 203, while at the same time, message 203 is transmitted from message memory segment 212b of network controller 210 into message memory segment 222b of adjacent controller 220, and thus overwrites message 204. Alternatively, one of messages 203, 204 may be initially transmitted to a buffer 211, 221, respectively, and deleted from the corresponding message memory segment, and then the other of messages 203, 204 is transmitted and is deleted from the corresponding message memory segment, in the event that synchronous message transmission is not supported.

In the second example, message memory 222a, 222b of adjacent controller 220 is full, and message congestion exists between network controller 210 and adjacent controller 220. In this example, adjacent controller 220 now sends priority information of all of its stored messages 202 and 204, or preferably, only the priority information of the lowest-priority message of messages 202 and 204, to network controller 210. As described above, network controller 210 compares the received priority information to the priority information of its own messages 201 and 203, and initiates a message exchange in the event that one of its messages 201 or 203 has a higher priority than one of messages 202 or 204, and in the event that this message, similarly as in FIG. 2, is message 203 which is intended for transmission on or via adjacent controller 220. Message exchange of messages 203 and 204 then proceeds similarly as described above.

As an alternative to the buffer shown in FIG. 2 for buffering messages during message exchange according to the present invention, and as an alternative to synchronous message transmission during message exchange according to the present invention, a separate memory location may be kept free in the message memories of the network controllers, so that a message may be buffered there in the event of a message exchange according to the present invention.

The priority information of the messages may preferably be stored in the data packet format of the messages, for example in the message header. An alternative option is a separate transmission via the communication connections of the message transmission, or also via separate communication connections between the network controllers of an on-chip network. The communication connections illustrated in FIG. 1 and FIG. 2 are not limited to single-wire lines. For example, for a parallel data transmission during the data exchange as described above as an alternative, parallel data channels must also be available between the network controllers. In addition to the message/data transmission, for the method according to the present invention it is also necessary to transmit control information (initiation or acknowledgment of the exchange) and the priority information between the network controllers.

These requirements may be met at the protocol level via multiple data lines or, for example, also via multiplex methods.

On the system/network level, the present invention may preferably be implemented in such a way that all network controllers are able to operate according to the present invention. For example, all controllers conduct the priority information of the highest-priority packets in their buffer to the adjacent nodes, which are located on the route of these messages. A network controller which is not able to forward the messages in its full message memory on account of congestion situations checks at its message inputs the priority information of its adjacent controllers. The network controller having the full message memory recognizes whether a message which has a higher priority than that of one of its buffered messages must be received from one of its neighbors. In this case, the network controller having the full message memory initiates a message exchange as described above. The role of the initiator of the protocol may also be switched, as likewise described above. For this purpose, the adjacent controllers having a full message memory conduct the information concerning the lowest message priority of messages in their message memories to all adjacent network controllers. A network controller recognizes when it must send a higher-priority message to the adjacent controller, and initiates the message exchange.

On the network level, it may also preferably be provided that a network controller exchanges priority information and messages according to the present invention not with just one adjacent controller, but, rather, with multiple adjacent controllers, optionally also at the same time. In such a case, a network controller may have not only one message memory and/or buffer, but, rather, multiple message memories or buffers, preferably one message memory and/or one buffer for each adjacent controller.

As a result of the method according to the present invention, in the event of congestion the forwarding of a highest-priority packet (message) is hindered only by the resulting complexity of the protocol. A clear dependency on lower-priority packets which could prevent forwarding due to congestion is lacking. The maximum propagation time of a highest-priority packet may thus be determined according to the formula below. n is the number of network controllers which a packet must pass on its route from the starting controller to the end controller. In the worst case, the above method must be carried out for each of these n controllers. In addition, m is the number of time units required by the method for exchanging messages, and t is the number of time units (for example, clock cycles or time requirements for asynchronous networks) required for transmitting a packet between two adjacent controllers. Thus, the maximum propagation time for highest-priority packets for a known route directly results as

T=(n−1)*(m+t)

However, it has been assumed that only one message/one packet, or a sufficiently small number of highest-priority messages/packets, is present in the network. The method has no deterministic propagation time prediction in the event that congestion were caused exclusively by highest-priority messages, for example (i.e., a message memory of a network controller is full with highest-priority messages, forwarding of these messages is not possible, and in an adjacent network controller another highest-priority message must wait due to this congestion).

For low-priority packets, it is difficult to make statements concerning the propagation time in any event. To prevent the situation that lower-priority messages have very long transmission times or possibly do not reach their destination at all due to the method according to the present invention, it is proposed that the low-priority messages are elevated in priority, for example as a function of the number of network controllers passed through, and/or also as a function of the number of message exchange processes according to the present invention in which the messages were involved.

To design the message routing in an on-chip network in a particularly efficient manner, it is also proposed to combine the method according to the present invention with existing routing methods, for example dynamic routing methods. In such a case, the method according to the present invention may be taken into account in the algorithm of the dynamic route determination.

1-13. (canceled)

14. A network controller in a network, comprising:
at least one message memory;
means for receiving and forwarding messages;
means for receiving, from at least one adjacent controller, priority information of messages stored in the adjacent controller, wherein the adjacent controller is a second network controller which is adjacent to the network controller in the network;
means for comparing the priority information of messages stored in the adjacent controller to priority information of messages stored in the message memory; and
means for performing, in the event of message congestion between the network controller and the adjacent controller, the following as a function of the comparison of the priority information:
sending at least one first message stored in the message memory to the adjacent controller;
deleting the first message from the message memory;
receiving from the adjacent controller at least one second message stored in the adjacent controller; and
storing the second message in the message memory.

15. The network controller as recited in claim 14, wherein, in the event that the message congestion results, at least in part, from the message memory being full, the comparing of the priority information includes determining whether the first message stored in the message memory has a lower priority than the second message which is stored in the adjacent controller and which is provided for one of transmission on or via the network controller, and if the first message stored in the message memory has a lower priority, the first message is sent to the adjacent controller and the first message in the message memory is replaced with the second message.

16. The network controller as recited in claim 14, wherein, in the event that the message congestion results, at least in part, from a first memory of the adjacent controller being full, the comparing of the priority information includes determining whether the first message which is stored in the message memory and which is provided for one of transmission on or via the adjacent controller has a higher priority than the second message stored in the adjacent controller, and if the first message has a higher priority, the first message is sent to the adjacent controller and the first message in the message memory is replaced with the second message.

17. The network controller as recited in claim 15, further comprising:
means for elevating the priority of the replaced first message as a function of at least one of (i) a number of replacement operations and (ii) a number of network controllers visited concerning the first message.

18. The network controller as recited in claim 16, further comprising:
means for elevating the priority of the replacing second message as a function of at least one of (i) a number of replacement operations and (ii) a number of network controllers visited concerning the second message.

19. The network controller as recited in claim 15, further comprising:
at least one reserved memory location for buffering at least one of the first and second messages during the exchange of the first message with the second message.

20. The network controller as recited in claim 19, wherein the reserved memory location is implemented by a separate buffer.

21. A network comprising:
at least two adjacent network controllers, wherein:
the at least two adjacent network controller have means for exchanging priority information of messages stored in the two adjacent network controllers;
at least one of the two adjacent network controllers has means for comparing the priority information of messages stored in the two adjacent network controllers; and
the at least two adjacent network controllers have means for performing, in the event of a full message memory of the first one of the at least two adjacent network controllers, the following:
sending a first lower-priority message from the full message memory of the first network controller to the second one of the at least two adjacent network controllers;
deleting the first message from the full message memory of the first network controller;
sending a second higher-priority message from a message memory of the second network controller, the second message being intended for one of transmission on or via the first network controller, from the second network controller to the first network controller; and
deleting the second message from the message memory of the second network controller.

22. The network as recited in claim 21, wherein the exchange of the priority information between the at least two adjacent network controllers takes place via data channels not used for transmission of the messages.

23. The network as recited in claim 21, wherein the exchange of the priority information between the at least two adjacent network controllers takes place via data channels used for transmission of the messages.

24. A routing method for messages in a network having at least two network controllers, comprising:
exchanging, between the at least two adjacent network controllers, priority information of messages stored in the two adjacent network controllers;
comparing, in at least one of the two adjacent network controllers, the priority information of messages stored in the two adjacent network controllers; and
performing the following in the event of a full message memory of the first of the at least two adjacent network controllers:
sending a first lower-priority message from the full message memory of the first network controller to the second one of the at least two adjacent network controllers;
deleting the first message from the full message memory of the first network controller;
sending a second higher-priority message from a message memory of the second network controller, the second message being intended for one of transmission on or via the first network controller, from the second network controller to the first network controller; and
deleting the second message from the message memory of the second network controller.

25. The routing method as recited in claim 24, wherein the priority information of the messages is stored in a data packet format of the messages.

26. The routing method as recited in claim 24, wherein the priority information of the messages is transmitted in addition to the messages.
